(19) United States
(12) Patent Application Publication
(10) Pub. No.: US 2008/0262652 A1
(43) Pub. Date: Oct. 23, 2008

(54) Method for an Industrial Robot

(75) Inventor: Peter Eriksson, Vasteras (SE)

Correspondence Address: VENABLE LLP, P.O. BOX 34385, WASHINGTON, DC, 20043-9998, US

(73) Assignee: ABB AB, Vasteras (SE)

(21) Appl. No.: 10/490,145

(22) PCT Filed: Sep. 16, 2002
(86) PCT No.: PCT/SE2002/001674

§ 371 Date: Oct. 25, 2004

(30) Foreign Application Priority Data
Sep. 19, 2001 (SE) 0103142.6

(51) Int. Cl. G06F 19/00; G06F 9/46

(52) U.S. Cl. 700/245; 901/50

(57) ABSTRACT

The invention relates to a method for an industrial robot that comprises a manipulator and a control system comprising a processor and a computer program that influences the processor and is adapted to control a process, wherein the computer program comprises a plurality of cooperating objects (44), for addressing said objects (44).

### FIELD OF THE INVENTION

The present invention relates to a method for an industrial robot that comprises a manipulator and a control system including a processor and a computer program that influences the processor and is adapted to control a process, wherein the computer program comprises a plurality of cooperating objects, for addressing said objects. Further, the invention relates to a system for process control, comprising an industrial robot with a manipulator and a control system including a processor and a computer program, influencing the processor, adapted to control the processor, wherein the computer program comprises a plurality of cooperating objects. The invention also relates to a computer program product and a computer-readable medium.

### BACKGROUND ART

Industrial robots are used to an increasing extent for carrying out certain tasks, for example operations such as spray painting, welding, materials handling, various forms of assembly, etc.

Currently used industrial robots are usually provided with a computer program for process control of the industrial robot. This computer program thus ensures that the robot carries out the desired tasks. Concurrently with such computer programs becoming increasingly more extensive and hence more complex, it has become increasingly more common to build up the computer program from a plurality of components, that is, a plurality of cooperating computer program parts. These components are often developed essentially independently of each other, whereby one requirement made is usually that each individual component shall be able to communicate with the other components. However, a consequence of this method is that each individual component in the computer program is implemented in a different way. Although it is possible for the components to communicate with each other, a disadvantage of this is that detailed knowledge as to how a component is built up and implemented is required to be able to obtain access to, supervise or influence different objects in such a component.

In the light of what has been stated above, there is thus a need to simplify the handling of different objects included in the above-mentioned type of computer programs.

### SUMMARY OF THE INVENTION

The object of the present invention is to suggest a method to satisfy the above-mentioned need.

According to a first aspect of the invention, this object is achieved by providing a method of the kind defined in the introductory part of the description, whereby an identity carrier is assigned to each object, which identity carrier contains an address, the address is brought to comprise a first address part corresponding to a first level in an organized structure, and the address is brought to comprise a second address part corresponding to an underlying second level, in relation to the first level, in the organized structure. Thus, all objects receive a unique address, the composition of which is independent of the type of the object. This is very advantageous since this enables unambiguous access to all the objects in the same way, that is, via said address. The term “object”, as used in this description and in the appended claims, is to be construed in a very broad sense and relates to anything that is possible to influence and/or to obtain information from.

According to a preferred embodiment of the invention, said address is brought to be of the type URL (Uniform Resource Locator), which entails simple and user-friendly remote access to said objects via networks that may be local or global, such as, for example, the Internet, since this is the currently predominant standard according to which resources accessible via networks are addressed.

Additional advantages of the method according to the invention will be clear from the following description.

According to a second aspect of the invention, the object is achieved by providing a system of the kind defined in the introductory part of the description, whereby each object has an identity carrier containing an address, the address comprises a first address part corresponding to a first level in an organized structure, and the address comprises a second address part corresponding to an underlying second level, in relation to the first level, in the organized structure.

According to a third aspect of the invention, the object is achieved by providing a computer program product comprising a computer program that may be read directly into the internal memory of a computer, the computer program being built up according to the above-described method and comprising instructions for a processor to carry out a plurality of events when the program is executed by the computer.

According to a fourth aspect of the invention, the object is achieved by providing a computer-readable medium comprising a computer program that is built up according to the method described above and comprises instructions for a processor to carry out a plurality of events.

### BRIEF DESCRIPTION OF THE DRAWINGS

The invention will be described in greater detail by means of embodiments with reference to the accompanying drawings, wherein

FIG. 1 schematically illustrates an industrial robot with an associated control unit, and

FIG. 2 schematically illustrates an organized structure of objects.

### DETAILED DESCRIPTION OF THE PREFERRED EMBODIMENTS

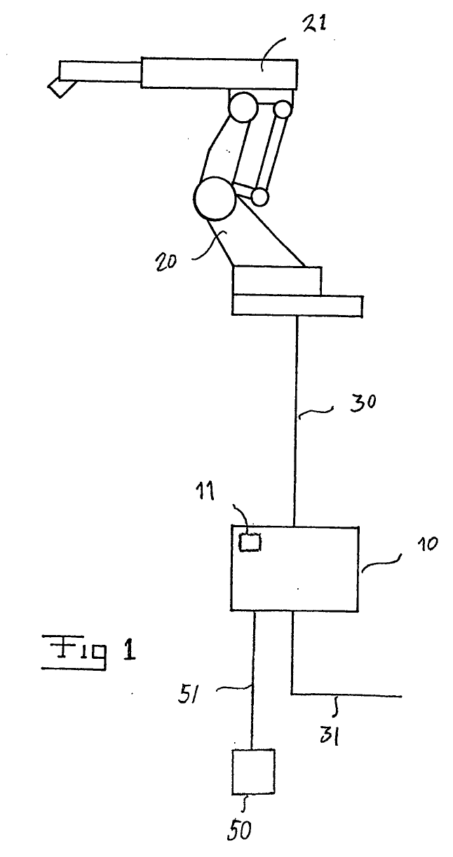

FIG. 1 schematically shows an industrial robot 20 to which a control unit 10 is connected via a communication line 30. A manipulator of the robot 20 is schematically indicated at 21. It is stressed that the industrial robot illustrated in FIG. 1 is only a very simplified form of an industrial robot, shown for the purposes of exemplification, and therefore it should in no way be interpreted in a way that may limit the scope of the invention. The invention is, of course, applicable to any arbitrary form of industrial robot. Further, FIG. 1 should not be interpreted such that the control unit 10 must be separated from the robot 20; it may just as well be part of the robot.

The control unit 10 includes a data-processing unit, schematically indicated by box 11, which preferably comprises some available type of microprocessor and also various forms of memories, databases and other necessary equipment for execution of computer-readable program code, more specifically a computer program for controlling processes of the industrial robot 20. Said computer program further comprises a plurality of different computer program components, which are preferably implemented in a program language or similar, suitable for the purpose, such as, for example, Java, Java Script, C, C++, Visual Basic. It is possible to carry out execution of said computer program in the data-processing unit present in the control unit 10, and in other devices with which the control unit is communicating. For example, it is possible to arrange a plurality of cooperating data-processing units, each of which being responsible for execution of a part of the computer program.

According to a preferred embodiment of the invention, the control unit 10 is connectible, directly or via some other equipment, to networks that may be local or global, such as, for example, the Internet, which in FIG. 1 is illustrated by the line 31. This makes possible, for example, remote access to said computer program, for example for programming the robot 20. It is also possible to transfer, via networks, various programs and data between remotely located units and the control unit.

According to another preferred embodiment of the invention, a device, schematically indicated at 50, is connectible, for example, via the control unit 10 to the robot 20 for programming the robot. The connection 51 to this device is, for example, arranged in the form of wireless connections, for example while using Bluetooth technique. This device 50 is preferably a programming unit, also referred to as a Teach Pendant Unit (TPU), and includes a display screen, which is preferably a pressure-sensitive screen, a so-called touch screen, by means of which inputs to the device are made. The device preferably also includes a joystick, with which movements of the robot may be controlled by an operator for programming purposes. According to various preferred embodiments, the device also comprises emergency switches, holding devices and other types of input units, such as function keys. According to other embodiments, the device may be connected to conventional keyboards and pointing devices such as a computer mouse.

The various components in said computer program comprise, for example, a configuration database, a movement system for controlling movements of different robots, program parts representing manipulators and various mechanical parts and shafts included in the robot. Further examples are components for status supervision of different parts of the control system of the robot, components for control/processing of signals, components for control/processing of input/output units and components for input and monitoring of functional values. Other examples of such components comprise a programming system for reading, writing, interpretation, and execution of data for carrying out individual tasks as well as sequences of tasks, and systems for supervision of events generated both by the computer program and by physical parts of a robot.

Further, said computer program comprises a plurality of objects of various types. Preferably, at least some of the objects are software representations of physical units. According to a preferred embodiment of the invention, the objects represent abstract entities such as, for example, components, constants, variables and signals, as well as concrete entities such as, for example, robots, physical units included in a robot as, for example, shafts, drive motors and input/output units.

According to the invention, each object in said computer program has an identity carrier comprising an address, wherein the address comprises a first address part corresponding to a first level in an organized structure, and wherein the address comprises a second address part corresponding to an underlying second level, in relation to the first level, in the organized structure. Thus, the composition of the address is independent of whether it relates to an abstract entity such as, for example, a constant or a computer program component, or whether it relates to a concrete physical entity such as, for example, a manipulator. This permits unambiguous access via the address to all objects included in such computer programs. Thus, no detailed knowledge of an object is needed, such as, for example, what type of object, program calls, or methods and the like, specific to the object, to be able to access, influence, or reprogram an object. The address is preferably arranged such that the location of the object, belonging to the address, in the organized structure may be read from the address itself, which further facilitates the access of the objects.

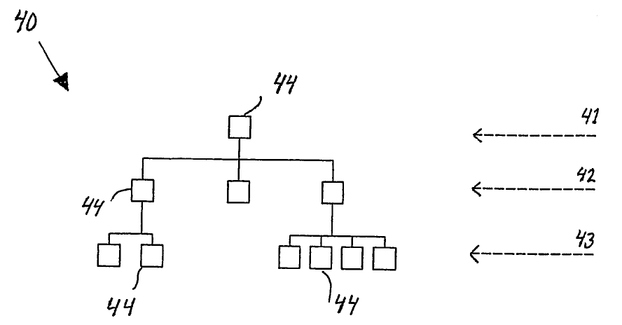

According to a preferred embodiment of the invention, the organized structure is a hierarchic structure. FIG. 2 shows a simple example of a hierarchic structure 40 of a plurality of objects 44. A hierarchic structure such as, for example, the exemplified structure 40, is characterized by an accurately determined superordination and subordination between the parts included in the structure, such as the objects 44 included in the structure. The illustrated structure has three levels, which is schematically illustrated by the dashed arrows 41, 42 and 43. For example, a so-called robot object, in the example in FIG. 2 the single object at level 41, has such a hierarchic structure. Positioned below this robot object is a plurality of objects, which in the example in FIG. 2 are illustrated by the objects at level 42. Below each one of the plurality of objects, there are then, in turn, zero or more objects, illustrated by the objects at level 43, and so on. A hierarchic structure may have an optional number of levels, and below each object at a special level there may be an optional number of objects at a lower level. In the illustrated example, the term “lower” is intended to refer to the downward direction in the figure so that, for example, level 42 is lower than level 41.

According to a preferred embodiment of the present invention, said address is of the URL (Uniform Resource Locator) type. By using this standard for addressing network-accessible resources, a simple means, known to users, is provided for indicating an identity for an object that is accessible via networks. An address of the URL type has, for example, the following form:

http://www.xyz.com/index.html

The first part states which protocol to be used for transferring, in this example, the electronic document represented by the file “index.html”. Of course, “http” (hypertext transfer protocol) is only given as an example of protocols and any other suitable protocol may, of course, be used. Then follows a domain name, or an IP address, and finally the search path to the object pointed out by the address. The above-mentioned address points out the file “index.html” on the domain “xyz.com”.

According to the invention, addresses of the URL type have, for example, the following form:

http://1.123.45.210/name1/progrsyst/supervisiontask/mod_id/routine/e10

This address points to an object with the name “e10”, which is an object of the type “routine” belonging to the object “mod_id”, that is, a module identity. This module belongs to the object “supervisiontask”, which, as is clear from the name, is a computer program component for carrying out a supervision task and which, in turn, belongs to the object “progrsyst”, that is, a computer program component for programming a control system for an industrial robot. The object “progrsyst” belongs to the object “name1”, which is a computer program for controlling an industrial robot. This computer program is to be found on the physical unit that has the IP address 1.123.45.210. It is clear from the example just described that, when using addresses of the URL type, the symbol “/” represents a transition between two levels in the hierarchic structure. With this method for constructing addresses for objects, the difference between addresses for objects at the same level in the structure will only be the name of the object, since the rest of the address describes the location of the object in the hierarchic structure. Preferably, addresses of the URL type are assigned to all objects in said computer program for controlling processes of an industrial robot, according to the same system as has been described above.

According to the present invention, access is thus provided in the same way to all objects included in a computer program for controlling processes of an industrial robot, preferably via an URL-type address. In this way, it is possible for the user to access all objects, via local and/or global networks, for example for supervision thereof or for programming of an industrial robot in accordance with specific requirements or wishes. In this context, the possibility, via networks, of adapting and tailoring computer programs for controlling processes of an industrial robot is a great advantage which, for example, may be applied to the field of design of solutions for electronic trade.

The invention is not, of course, in any way limited to the preferred embodiments described above. A plurality of possibilities of modifying these embodiments should be obvious to a person skilled in the art without this person, for that reason, deviating from the scope of the invention as defined in the appended claims.

For example, it is possible to apply the invention to a system where the industrial robot comprises a plurality of cooperating manipulators.

Further, objects may have their domiciles on servers, in primary and secondary memories, etc.

1. A method for an industrial robot that comprises at least one manipulator and a control system including a processor and a computer program that influences the processor and is adapted to control a process, wherein the computer program comprises a plurality of cooperating objects, for addressing said objects, wherein
an identity carrier containing an address is assigned to each object,
the address is brought to comprise a first address part corresponding to a first level in an organized structure,
the address is brought to comprise a second address part corresponding to an underlying second level, in relation to the first level, in the organized structure and
at least some of the objects are software representations of physical units or containers of logic for movement of one or several manipulators,
wherein addressing said objects enables a uniform access to objects, via local and/or global networks, for supervision, installation/commissioning and for maintainability of a industrial robot system comprised of at least one manipulator.

2. The method according to claim 1, wherein the structure is brought to be a hierarchic structure.

3. The method according to claim 1 wherein said address is brought to be of the URL type.

4. The method according to claim 1, wherein each address is arranged such that the location of the object, belonging to the address, in the organized structure may be read from the address.

5. The method according to claim 1, wherein the first address part is brought to comprise a reference to a physical unit on which the objects are stored.

6. The method according to claim 1, wherein the first address part is brought to comprise an IP address.

7. The method according to claim 1, wherein the second address part is brought to comprise a search path to the object to which the address refers.

8. The method according to claim 1, wherein the second address part is brought to comprise a name of the object to which the address refers.

9. A computer program product comprising a computer program that may be directly read into the internal memory of a computer, wherein the computer program is built up according to claim 1 and comprises instructions for a processor, included in a control system comprised in an industrial robot, to carry out a plurality of events when the program is executed by the computer.

10. The computer program product according to claim 9, provided at least partly via a network such as, for example, the Internet.

11. A computer-readable medium comprising a computer program that is built up according to claim 1 and contains instructions for a processor, included in a control system comprised in an industrial robot, to carry out a plurality of events.

12. A system for process control comprising an industrial robot with a manipulator and a control system comprising a processor and a computer program that influences the processor and is adapted to control the process, wherein the computer program comprises a plurality of cooperating objects
wherein each object has an identity carrier containing an address,
the address comprises a first address part corresponding to a first level in an organized structure, and
the address comprises a second address part corresponding to an underlying second level, in relation to the first level, in the organized structure and
at least some of the objects are software representations of physical units.

13. The system according to claim 12, wherein the structure is a hierarchic structure.

14. The system according to claim 12 wherein said address is of the URL type.

15. The system according to claim 12 wherein each address is arranged such that the location of the object, belonging to the address, in the organized structure may be read from the address.

16. The system according to claim 12, wherein the first address part comprises a reference to a physical unit on which the objects are stored.

17. The system according to claim 12, wherein the first address part comprises an IP address.

18. The system according to claim 12, wherein the second address part comprises a search path to the object to which the address refers.

19. The system according to claim 12, wherein the second address part comprises a name of the object to which the address refers.

20. Use of a system according to claim 12 for controlling welding processes.

21. Use of a system according to claim 12 for controlling painting processes.

22. Use of a system according to claim 12 for controlling assembly processes.
